(19) United States
(12) Patent Application Publication
(10) Pub. No.: US 2024/0378444 A1
(43) Pub. Date: Nov. 14, 2024

(54) SYSTEMS AND METHODS FOR LEARNING FROM UNLABELED DATA AND FINE-TUNING OF MODELS USING PERSISTENT HOMOLOGY

(71) Applicant: JPMORGAN CHASE BANK, N.A., New York, NY (US)

(72) Inventors: Najah GHALYAN, Wayne, NJ (US); Yash SATSANGI, Tilburg (NL); Kostis GOURGOULIAS, London (GB); Joseph SABELJA, Tuckahoe, NY (US); Sean MORAN, London (GB)

(21) Appl. No.: 18/343,320

(22) Filed: Jun. 28, 2023

(30) Foreign Application Priority Data
May 12, 2023 (GR) 20230100384

(51) Int. Cl. G06N 3/088; G06N 3/0455

(52) U.S. Cl. CPC G06N 3/088; G06N 3/0455

(57) ABSTRACT

Systems and methods for learning from unlabeled data and fine-tuning of models using persistent homology are disclosed. A method may include: (1) receiving a dataset from a dataset database; (2) receiving model parameters of an embedding part of a model; (3) performing text embedding on the dataset; (4) generating a persistent diagram of 0-Homology Group of an embedding manifold for the text embedding, wherein the embedding manifold is from the embedding part of the model; (5) fitting a probabilistic model comprising mixing components computed using a model selection criterion; (6) generating an unsupervised class separability metric from a log-likelihood of 0-homology group points conditioned on the probabilistic model; (7) determining whether the unsupervised class separability metric meets a prespecified threshold or not; and (8) fine tuning the model parameters in response to a specified threshold or maximum number of fine tuning shots are not met.

### RELATED APPLICATIONS

This application claims priority to, and the benefit of, Greek patent application No. 20230100384, filed May 12, 2023, the disclosure of which is hereby incorporated, by reference, in its entirety.

### BACKGROUND OF THE INVENTION

### 1. Field of the Invention

Embodiments generally relate to systems and methods for learning from unlabeled data and semi-supervised learning-based fine-tuning of models by leveraging topological characteristics of data manifolds using the method of persistent homology.

### 2. Description of the Related Art

In mathematics, homology is a general way of associating a sequence of algebraic objects, such as abelian groups, with other mathematical objects, such as topological spaces (e.g., data manifolds). In this context, the homology of data manifolds are critically important for the characterization and classification of these manifolds, which provides an efficient means of information extraction from high-dimensional data in a manner that is insensitive to the selection of a particular metric; it also provides dimensionality reduction and robustness to noise.

The method of persistent homology is one of the Topological Data Analysis (TDA) techniques that makes use of homology groups of a data manifold to provide information about the underlying stochastic process that generated the dataset.

Given a dataset X, the method of persistent homology generates 2-dimensional points that involve a rich representation of the dataset and describe nth homology groups Hₙ(X) of the dataset manifolds, n=0, 1, 2, . . . , where H₀(X) describes connectivity and clustering properties of the data manifold, while Hₙ(X) with n>0 describes n-dimensional cavities in the data manifolds.

### SUMMARY OF THE INVENTION

Systems and methods for learning from unlabeled data and fine-tuning of models using persistent homology are disclosed.

In embodiments, an unsupervised metric may quantify class separability of dataset without requiring labels based on homology groups of the dataset manifold is disclosed. This unsupervised metric may be used, for example, for semi-supervised learning where both labeled and unlabeled data are used for training models. This may be done by generating a hybrid loss function that consists of a supervised part (e.g., binary cross entropy) that requires labeled samples and an unsupervised part that does not require labeled samples like the class separability metric. The training process may be done by jointly optimizing this hybrid loss using, for example, Pareto optimization.

The unsupervised metric may also be used for transductive learning where a model's parameters are adjusted in the operational phase based on test batches of unlabeled samples collected in the operational phase.

The unsupervised metric may also be used for fine-tuning of pretrained classifiers based on class separability of feature space generated by feature generation part of the model (e.g., the first few layers in neural network classifiers).

Embodiments may also be used for fine-tuning of large language models.

In one embodiment, a method for fine-tuning of models using persistent homology may include: (1) receiving, by a fine-tuning computer program, a dataset from a dataset database; (2) receiving, by the fine-tuning computer program, model parameters of an embedding part of a model; (3) performing, by the fine-tuning computer program, text embedding on the dataset; (4) generating, by the fine-tuning computer program, a persistent diagram of 0-Homology Group of an embedding manifold for the text embedding, wherein the embedding manifold is from the embedding part of the model; (5) fitting, by the fine-tuning computer program, a probabilistic model comprising mixing components computed using a model selection criterion; (6) generating, by the fine-tuning computer program, an unsupervised class separability metric from a log-likelihood of 0-homology group points conditioned on the probabilistic model; (7) determining, by the fine-tuning computer program, whether the unsupervised class separability metric meets a prespecified threshold or not; and (8) fine tuning, by the fine-tuning computer program, the model parameters in response to a specified threshold or maximum number of fine tuning shots are not met.

In one embodiment, the dataset may comprise logs that are generated by switches and/or routers in a network of electronic devices.

In one embodiment, the probabilistic model may be trained on H0 points using the Expectation Maximization method.

In one embodiment, the method may also include performing, by the fine-tuning computer program, preprocessing of raw data in the dataset, wherein the preprocessing comprises text-to-text conversion of the raw data.

In one embodiment, the model parameters may include weights and biases of each neuron in layers of the model.

In one embodiment, the probabilistic model may include a Gaussian Mixture Model, and the model selection criterion may include a Bayesian information criterion.

In one embodiment, the model may include a large language model.

According to another embodiment, a system may include: a logs/text database comprising a dataset generated by a plurality of source devices; a model parameter database storing a plurality of parameters of an embedding part of a model; and an electronic device executing a fine-tuning computer program that receives model parameters of an embedding part of a model, performs text embedding on the dataset, generates a persistent diagram of 0-Homology Group of an embedding manifold for the text embedding, wherein the embedding manifold is from the embedding part of the model, fits a probabilistic model comprising mixing components computed using a model selection criterion, generates an unsupervised class separability metric from a log-likelihood of 0-homology group points conditioned on the probabilistic model, determines whether the unsupervised class separability metric meets a prespecified threshold or not, and fine tunes the model parameters in response to a specified threshold or maximum number of fine tuning shots are not met.

In one embodiment, the dataset may comprise logs that are generated by switches and/or routers in a network of electronic devices.

In one embodiment, the probabilistic model may be trained on H0 points using the Expectation Maximization method.

In one embodiment, the fine-tuning computer program may preprocess raw data in the dataset, wherein the preprocessing comprises text-to-text conversion of the raw data.

In one embodiment, the model parameters may include weights and biases of each neuron in layers of the model.

In one embodiment, the probabilistic model may include a Gaussian Mixture Model, and the model selection criterion may include a Bayesian information criterion.

In one embodiment, the model may include a large language model.

According to another embodiment, a non-transitory computer readable storage medium may include instructions stored thereon, which when read and executed by one or more computer processors, cause the one or more computer processors to perform steps comprising: receiving a dataset from a dataset database; receiving model parameters of an embedding part of a model; performing text embedding on the dataset; generating a persistent diagram of 0-Homology Group of an embedding manifold for the text embedding, wherein the embedding manifold is from the embedding part of the model; fitting a probabilistic model comprising mixing components computed using a model selection criterion; generating an unsupervised class separability metric from a log-likelihood of 0-homology group points conditioned on the probabilistic model; determining whether the unsupervised class separability metric meets a prespecified threshold or not; and fine tuning the model parameters in response to a specified threshold or maximum number of fine tuning shots are not met.

In one embodiment, the dataset may comprise logs that are generated by switches and/or routers in a network of electronic devices.

In one embodiment, the probabilistic model may be trained on H0 points using the Expectation Maximization method.

In one embodiment, the on-transitory computer readable storage medium may also include instructions stored thereon, which when read and executed by one or more computer processors, cause the one or more computer processors to preprocess raw data in the dataset, wherein the preprocessing comprises text-to-text conversion of the raw data.

In one embodiment, the model parameters may include weights and biases of each neuron in layers of the model.

In one embodiment, the probabilistic model may include a Gaussian Mixture Model, and the model selection criterion may include a Bayesian information criterion.

In one embodiment, the model may include a large language model.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for learning from unlabeled data and fine-tuning of models using persistent homology according to an embodiment.

FIG. 2 depicts a method for learning from unlabeled data and fine-tuning of models using persistent homology according to an embodiment.

FIG. 3 depicts an exemplary computing system for implementing aspects of the present disclosure.

### DETAILED DESCRIPTION OF PREFERRED EMBODIMENTS

Embodiments are directed to systems and methods for learning from unlabeled data and fine-tuning of models using persistent homology. The models may be used for text classification, among other things.

Given a model, such as a large language model with pre-trained large set of parameters, embodiments disclose an unsupervised-learning method for deciding how many shots are needed to fine-tune the model's parameters so that the model fits the given use case without overfitting on the training samples used for the fine-tuning.

For example, a metric, referred to herein as the “unsupervised class separability metric,” may leverage topological characteristics of data manifolds to quantify class separability of the data without requiring labels for the data. The unsupervised class separability metric may also be used, for example, for data grouping, detecting datasets duplicates, and assessment of model's generalizability to a dataset that the model has not trained on, and whether the model needs to be trained on this dataset or not.

The unsupervised class separability metric for class separability of a dataset X may be computed based on persistent diagram points that correspond to the 0-homology group H₀(X). This may be accomplished by fitting a probabilistic model, such as a Gaussian mixture model (GMM), H₀, on H₀ points from the persistent diagram, where the number of mixture components is greater than 1 and may be computed using a model selection criterion, such as the Bayesian information criterion (BIC). The unsupervised class separability metric may be generated by computing the log-likelihood of the H₀ points conditioned on the trained GMM_H₀. A data manifold with good class separability tends to generate H₀ points that tend to group into distinct clusters, while a data manifold with bad class separability tends to generate H₀ points that are more spread and has less tendency to group into distinct clusters. Thus, the computed conditional log-likelihood tends to increase when there is good class separability, and tends to decrease when we have bad class separability.

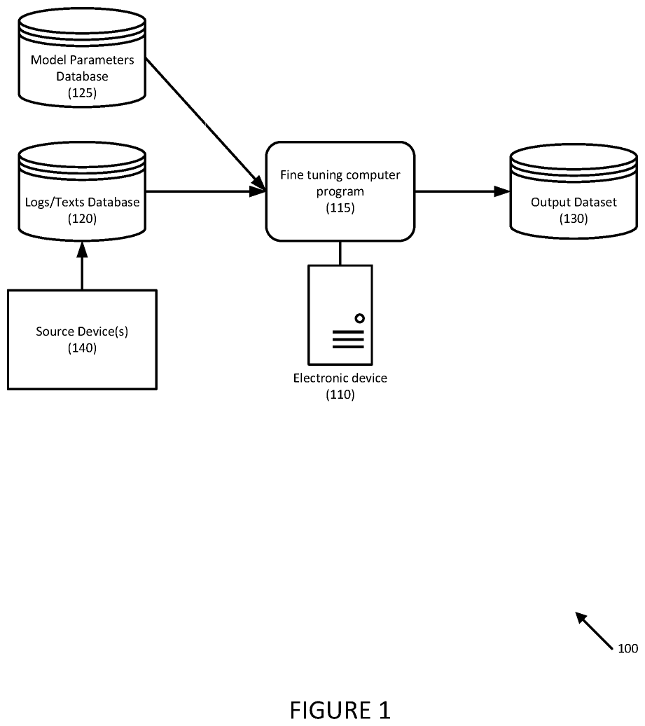

Referring to FIG. 1, a system for learning from unlabeled data and fine-tuning of models using persistent homology is disclosed according to embodiments. System 100 may include electronic device 110, such as servers (e.g., physical and/or cloud based), computers (e.g., workstations, desktops, notebooks, laptops, tablets, etc.), smart devices, Internet of Things (IoT) appliances, etc. Electronic device 110 may execute fine-tuning computer program 115, which may receive logs or text from logs/text database 120. In one embodiment, the data/logs may be unstructured data. Logs may be generated, for example, by source devices 140, such as a network of switches and routers that provide information on the network health and performance of the switches, routers, and the network.

In embodiments, the logs may include involve information about how the switches, routers, and/or other equipment are performing, whether they are healthy or experiencing performance degradation, etc. The logs may also include dates and times.

Fine-tuning computer program 115 may generate an unsupervised class separability metric that may be used to quantify the class separability of logs/text data in the embedding space, and to assess the fine-tuning process of the embedding part of, for example, a large language model. Fine-tuning computer program 115 may output a dataset to output dataset 130. Output dataset 130 may be a set of fine-tuned parameters of the large language model, which may be consumed by one or more downstream systems (not shown).

Model parameters, such as large language model parameters, may be provided to fine-tuning computer program 115 from model parameter database 125. The parameters may be the parameters of an embedding part of a model. The embedding part may include a plurality of layers. The model parameters may include, for example, the weights and biases of each neuron in the layers.

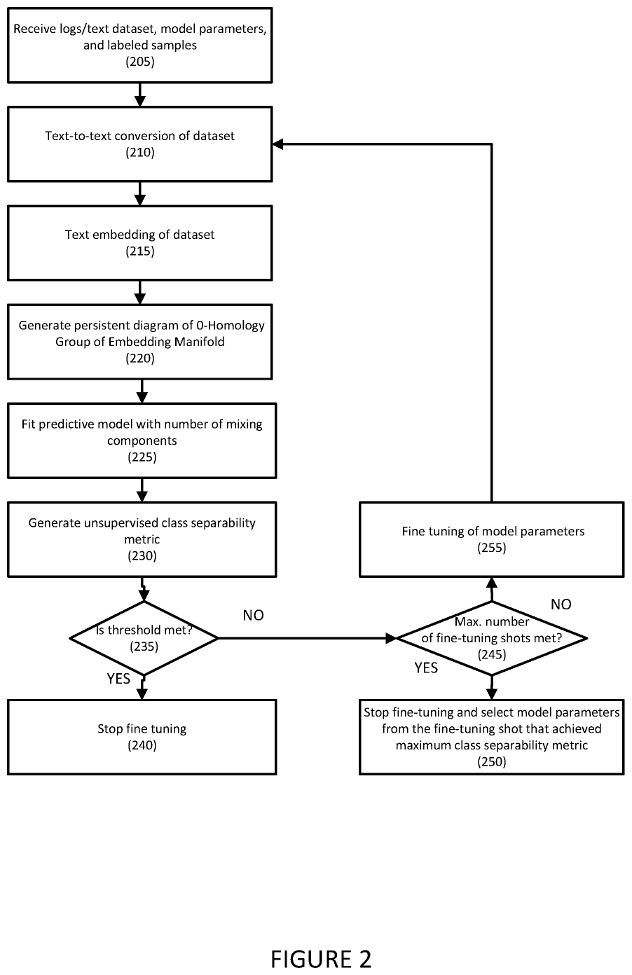

Referring to FIG. 2, a method for learning from unlabeled data and fine-tuning of models using persistent homology is disclosed according to an embodiment.

In step 205, a fine-tuning computer program may receive a dataset of logs and/or texts from a log/text dataset database. The logs may be generated, for example, by switches, routers, etc. in a computer network.

The fine-tuning computer program may also receive the model parameters from, for example, a model parameters database. The model parameters may include, for example, the weights and biases of each neuron in the network layers of the embedding part of the large language model.

The fine-tuning computer program may also receive a set of labeled samples that may be used for fine tuning.

In step 210, the fine-tuning computer program may perform text-to-text conversion on the dataset. For example, the fine-tuning computer program may convert a time series of logs to text. The conversion may involve an artificial intelligence operation performed by a transformer that generates a summary text from the time series of logs. For example, embodiments may use an encoder-decoder transformer, such as a neural network with an attention model. Examples of the encoder-decoder components of such transformers include variants of Recurrent Neural Networks (RNNs), such as Gated Recurrent Neural Network (GRU) or Long Short Term Memory (LSTM).

In step 215, the fine-tuning computer program may perform text embedding on the dataset. For example, the fine-tuning computer program may convert the text into numerical features, using, for example, one or more neural network and the model parameters. For example, Setfit may be used to perform the text embedding.

In step 220, the fine-tuning computer program may generate a persistent diagram of 0-Homology Group of the embedding manifold for the text embedding. For example, the embedding manifold may be from the embedding part of the large language model.

In step 225, the fine-tuning computer program may fit a probabilistic model, such as a Gaussian Mixture Model, with number of mixing components computed using a model selection criterion such as the Bayesian information criterion (BIC). For example, the Expectation Maximization method may be used to train the probabilistic model to find the logarithmic likelihood of the H0 point, which may quantify the class separability of the underlying manifold. An example of the Expectation Maximization method is provided in Murphy, K. P., “Machine Learning: A Probabilistic Perspective,” MIT Press (2012), the disclosure of which is hereby incorporated, by reference, in its entirety. The rationale is that this likelihood would tend to increase when H0 points tend to group into clusters, and decrease when they tend to be spread.

In step 230, the fine-tuning computer program may generate the unsupervised class separability metric, Lᵢ, from the probabilistic model. For example, the unsupervised class separability metric Lᵢ may be calculated using the following equation:

$${L}_{i} = log p ( {D}_{{H}_{0}} \vert {GMM}_{{H}_{0}} )$$

where D_{H}_{₀} is the H₀ persistent diagram points and GMM_{H}_{₀} is a Gaussian Mixture Model fitted on D_{H}_{₀}.

In step 235, if the unsupervised class separability metric Lᵢ meets a threshold (e.g.,

$${max}_{i} ( {L}_{i} )$$

indicating that a satisfactory level of class separability has been achieved, in step 240, fine tuning may stop. The value of this threshold may be computed based on the performance of the model on labeled samples, for which a class separability threshold that is achieving a good performance may be identified.

In one embodiment, if the set of labeled samples is not available, the process may continue to step 245.

If the unsupervised class separability metric Lᵢ does not meet the specified threshold, or if a threshold is not available due to lack of a set of labeled data, in step 245, the fine-tuning computer program may determine if the maximum number of fine-tuning shots have been performed. In one embodiment, the maximum number of fine-tuning shots may be specified by the user.

If it has, in step 250, the fine tuning is stopped and the large language parameters from the fine-tuning shot that achieved maximum class separability metric (Lᵢ) are selected.

In one embodiment, each fine-tuning shot may need a labeled sample. Thus, the maximum number of fine-tuning shots may be based on the number of available labeled samples.

If the maximum number of fine-tuning shots have not been performed, the process may continue to step 255, wherein the large language parameters may be adjusted.

After the model parameters are adjusted, the process may continue to step 210 for another fine-tuning shot for another fine-tuning assessment, because the fine tuning shot is already performed in step 255.

An example of a use case is Software-Defined Networking Platform anomaly detection. In a continuous integration/continuous deployment pipeline, virtualized private clouds are often used to provide a single consistent infrastructure that reduces operational complexity and cost. This delivers value and savings on two fronts, utilization and capacity provisioning for varying demands by combining compute optimization, host consolidation and networking components. This also saves operational costs by combined lifecycle management of components (troubleshooting, repaving etc.) and orchestrated and automated service delivery (build, deploy or migrate new and existing applications).

Standardizing and streamlining these services helps significantly in reducing the total cost of ownership (TCO). This may be done using a system that may be aimed at virtualizing compute, networking, and storage, such as a software-defined network (SDN). A SDN may include three main virtual layers, such as a compute layer, a networking layer, and a storage layer, with each layer having a large number of components/nodes such as virtual machines, hosts, vSAN clusters, etc. A large language model may be used for detecting accumulating anomalies and system's degradation in early stages using logs. This may be beneficial in mitigating the risk of prolonged service disruptions by dynamically triggering automated corrective actions to restore the environment to base operational state with minimal manual operator intervention.

One of the challenges for this anomaly detection task is the dynamic and time-varying nature of a system where a large number of virtual machines dynamically change their topology and move from hosts to hosts, in addition to the continuous version upgrade of components which may make behavior more stochastic and dynamic. This time-varying nature of dynamics, combined with the complex structure of and the complicated interdependencies between its various layers and nodes, makes a non-stationary complex stochastic process. In this context, the unsupervised class separability metric may be used to continuously monitor class separability of model's embedding manifolds and develop an efficient pipeline that can dynamically trigger fine-tuning shots as needed, which may make the anomaly detection pipeline less prone to the adaptively changing dynamics of the system.

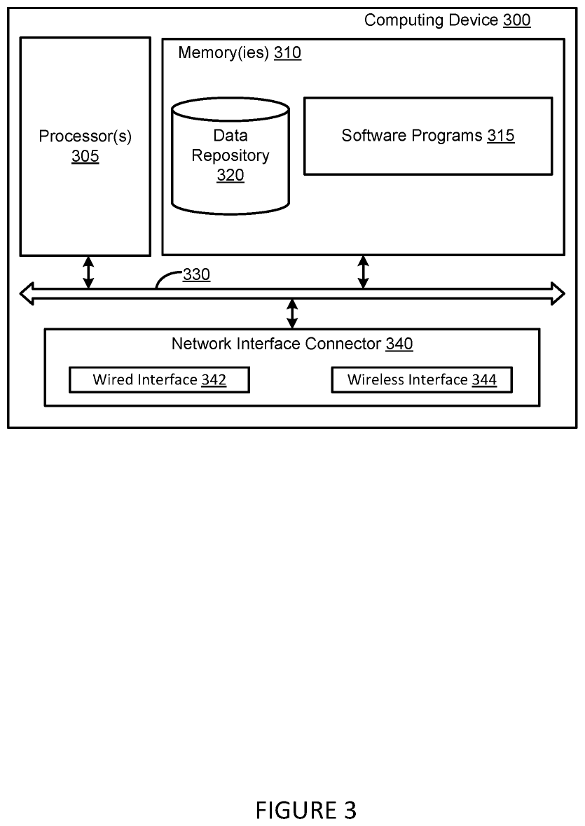

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for learning from unlabeled data and fine-tuning of models using persistent homology, comprising:
receiving, by a fine-tuning computer program, a dataset from a dataset database;
receiving, by the fine-tuning computer program, model parameters of an embedding part of a model;
performing, by the fine-tuning computer program, text embedding on the dataset;
generating, by the fine-tuning computer program, a persistent diagram of 0-Homology Group of an embedding manifold for the text embedding, wherein the embedding manifold is from the embedding part of the model;
fitting, by the fine-tuning computer program, a probabilistic model comprising mixing components computed using a model selection criterion;
generating, by the fine-tuning computer program, an unsupervised class separability metric from a log-likelihood of 0-homology group points conditioned on the probabilistic model;
determining, by the fine-tuning computer program, whether the unsupervised class separability metric meets a prespecified threshold or not; and
fine tuning, by the fine-tuning computer program, the model parameters in response to a specified threshold or maximum number of fine tuning shots are not met.

2. The method of claim 1, wherein the dataset comprises logs that are generated by switches and/or routers in a network of electronic devices.

3. The method of claim 1, wherein the probabilistic model is trained on H0 points using the Expectation Maximization method.

4. The method of claim 1, further comprising:
performing, by the fine-tuning computer program, preprocessing of raw data in the dataset, wherein the preprocessing comprises text-to-text conversion of the raw data.

5. The method of claim 1, wherein the model parameters comprise weights and biases of each neuron in layers of the model.

6. The method of claim 1, wherein the probabilistic model comprises a Gaussian Mixture Model, and the model selection criterion comprises a Bayesian information criterion.

7. The method of claim 1, wherein the model comprises a large language model.

8. A system, comprising:
a logs/text database comprising a dataset generated by a plurality of source devices;
a model parameter database storing a plurality of parameters of an embedding part of a model; and
an electronic device executing a fine-tuning computer program that receives model parameters of an embedding part of a model, performs text embedding on the dataset, generates a persistent diagram of 0-Homology Group of an embedding manifold for the text embedding, wherein the embedding manifold is from the embedding part of the model, fits a probabilistic model comprising mixing components computed using a model selection criterion, generates an unsupervised class separability metric from a log-likelihood of 0-homology group points conditioned on the probabilistic model, determines whether the unsupervised class separability metric meets a prespecified threshold or not, and fine tunes the model parameters in response to a specified threshold or maximum number of fine tuning shots are not met.

9. The system of claim 8, wherein the dataset comprises logs that are generated by switches and/or routers in a network of electronic devices.

10. The system of claim 8, wherein the probabilistic model is trained on H0 points using the Expectation Maximization method.

11. The system of claim 8, wherein the fine-tuning computer program preprocesses raw data in the dataset, wherein the preprocessing comprises text-to-text conversion of the raw data.

12. The system of claim 8, wherein the model parameters comprise weights and biases of each neuron in layers of the model.

13. The system of claim 8, wherein the probabilistic model comprises a Gaussian Mixture Model, and the model selection criterion comprises a Bayesian information criterion.

14. The system of claim 8, wherein the model comprises a large language model.

15. A non-transitory computer readable storage medium, including instructions stored thereon, which when read and executed by one or more computer processors, cause the one or more computer processors to perform steps comprising:
receiving a dataset from a dataset database;
receiving model parameters of an embedding part of a model;
performing text embedding on the dataset;
generating a persistent diagram of 0-Homology Group of an embedding manifold for the text embedding, wherein the embedding manifold is from the embedding part of the model;
fitting a probabilistic model comprising mixing components computed using a model selection criterion;
generating an unsupervised class separability metric from a log-likelihood of 0-homology group points conditioned on the probabilistic model;
determining whether the unsupervised class separability metric meets a prespecified threshold or not; and
fine tuning the model parameters in response to a specified threshold or maximum number of fine tuning shots are not met.

16. The non-transitory computer readable storage medium of claim 15, wherein the dataset comprises logs that are generated by switches and/or routers in a network of electronic devices.

17. The non-transitory computer readable storage medium of claim 15, wherein the probabilistic model is trained on H0 points using the Expectation Maximization method.

18. The non-transitory computer readable storage medium of claim 15, further comprising including instructions stored thereon, which when read and executed by one or more computer processors, cause the one or more computer processors to perform preprocessing of raw data in the dataset, wherein the preprocessing comprises text-to-text conversion of the raw data.

19. The non-transitory computer readable storage medium of claim 15, wherein the model comprises a large language model, and the model parameters comprise weights and biases of each neuron in layers of the model.

20. The non-transitory computer readable storage medium of claim 15, wherein the probabilistic model comprises a Gaussian Mixture Model, and the model selection criterion comprises a Bayesian information criterion.
